(19) United States
(12) Patent Application Publication
(10) Pub. No.: US 2004/0268400 A1
(43) Pub. Date: Dec. 30, 2004

(54) Quick starting video content

(75) Inventors: Sumedh N. Barde, Redmond, WA (US); Sohail Baig Mohammed, Redmond, WA (US)

Correspondence Address: LEE & HAYES PLLC, 421 W RIVERSIDE AVENUE SUITE 500, SPOKANE, WA, 99201

(73) Assignee: MICROSOFT CORPORATION, REDMON, WA (US)

(21) Appl. No.: 10/606,466

(22) Filed: Jun. 26, 2003

(51) Int. Cl. H04N 7/173; H04N 5/45; H04N 7/16

(52) U.S. Cl. 725/94; 725/89; 725/134; 725/142

(57) ABSTRACT

Systems and methods are described for achieving quick startup of streaming video content. Streaming video content is provided in two parts generally comprising a static image and dynamic video content. A streaming media player is configured to buffer the static image and display it promptly while buffering the remaining video content in the background. Benefits of the disclosed systems and methods include a reduced waiting period between the selection of video content and the playback of content by a media player.

### TECHNICAL FIELD

The present disclosure generally relates to streaming media, and more particularly, to achieving a quick startup and seamless playing of streaming video content.

### BACKGROUND

Content streaming, such as the streaming of audio, video, and/or text media content is becoming increasingly popular. The term “streaming” is typically used to indicate that the data representing the media is provided over a network to a client computer and the client computer renders the streaming content as it is received from a network server, rather than waiting for an entire “file” to be delivered.

When media content is “streamed” over a network, it is typically streamed in data packets. However, there is typically no guarantee that the data packets will arrive at their destination in the same order in which they are sent, or even that they will arrive at their destination at all. Additionally, there is typically no guarantee that the time it takes a data packet to travel from the source to the destination will be of specific duration, or even that the time will be the same for different data packets.

In order to account for these variances in data delivery to a client computer, the client computer maintains a buffer of data, typically on the order of three to five seconds worth of data. This buffer allows the client computer to smooth out the variances in data delivery so that they are not as noticeable to the user during playback of the content. However, one problem with this buffering is that it causes the user to have to wait for the buffer to be initially filled before playback of the content begins. Thus, upon selecting content for playback, users experience a delay in the start of playback that is generally about as long as the amount of time set in the buffer on the playback application (e.g., 3-5 seconds). This delay can be longer depending on the buffer setting and network glitches affecting the data transfer rate.

As an example, when a user selects content for playback through a media playback application running on a client computer, a blank screen is typically displayed along with a buffering message indicating that a certain percentage of the content is buffered. The blank screen and the buffering message continue to be displayed until the percentage of buffering reaches 100%, at which time the content begins playing through the playback application's user interface. Such buffering delays are generally regarded as an unavoidable cost of playing streaming media content (e.g., video content) over the Internet. However, users who are accustomed to the instant startup behavior of television can find buffering delays to be quite annoying. Thus, buffering delay has been one of the hindrances in the mass adoption of current general-purpose streaming technologies.

Accordingly, the need exists for ways to reduce the waiting time involved in playing video content over a network such as the Internet.

### SUMMARY

Quick starting video content is described herein.

In accordance with one implementation, a static image is received from a content provider and displayed while the video content is buffered from the content provider. The static image can be displayed until the buffering is complete, or, for a minimum fixed duration if the buffering is complete prior to expiration of the fixed duration.

In accordance with another implementation, the last frame of a first video clip can be displayed while a second video clip continues buffering if the second clip is not fully buffered by the time the first clip is done playing.

In accordance with another implementation, a static image can be buffered during playback of a first video clip and then displayed while a second video clip is buffered. The static image can be displayed until the buffering of the second clip is complete, or for a minimum fixed duration if the buffering happens to be complete prior to expiration of the fixed duration.

### BRIEF DESCRIPTION OF THE DRAWINGS

The same reference numerals are used throughout the drawings to reference like components and features.

FIG. 1 illustrates an exemplary network environment for implementing quick starting video content.

FIG. 2 illustrates exemplary client and server devices.

FIG. 3 illustrates an example graphical user interface of a streaming media player being implemented through an Active X control in an HTML window.

FIG. 4 illustrates an example of a play-list in the prior art that might represent a play-list accessed when a user selects video content for playback.

FIG. 5 illustrates an example of a time line for buffering and playing back video content.

FIG. 6 illustrates an example graphical user interface of a streaming media player being implemented through an Active X control in an HTML window.

FIG. 7 illustrates an example of a time line for buffering and playback of video content.

FIG. 8 illustrates an embodiment of a stitched-reference play-list configured to control a streaming media player.

FIG. 9 provides an example of a still image logo displayed on an example graphical user interface of a streaming media player.

FIG. 10 illustrates another exemplary embodiment of a stitched-reference play-list configured to control a streaming media player.

FIG. 11 illustrates another exemplary embodiment of a stitched-reference play-list configured to control a streaming media player.

FIG. 12 illustrates another exemplary embodiment of a stitched-reference play-list configured to control a streaming media player.

FIGS. 13-17 illustrate block diagrams of exemplary methods for achieving quick startup of video content in a streaming media player.

FIG. 18 illustrates an exemplary computing environment suitable for implementing a client computing device and a content server computing device.

### DETAILED DESCRIPTION

### OVERVIEW

The following discussion is directed to systems and methods for achieving quick startup of streaming video content. Streaming video content is provided in two parts generally comprising a static/still image and dynamic video content. “Static image” and “still image” are used synonymously throughout this description. The static image can be the first frame of the video content that represents an introductory section of the video content depicting a motionless image (e.g., an FBI warning). The static image may also be a logo or advertisement inserted by a content provider, when, for example, the video content does not include an introductory portion depicting a motionless image. A streaming media player is configured to buffer the static image and display it promptly while buffering the remaining video content in the background.

Benefits of the disclosed systems and methods include a reduced waiting period between the selection of video content and the playback of content by a media player. There are both real and perceived reductions in the time between video content selection and video content playback. The reduction in time between the selection of media content and the playback of content on a media player makes the streaming video experience via a network (e.g., the Internet) closer to the experience of watching television.

### EXEMPLARY ENVIROMENT

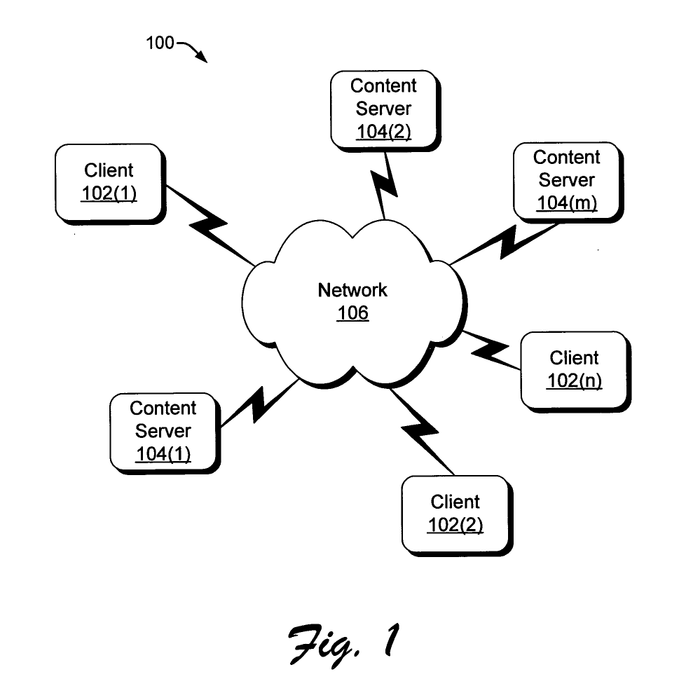

FIG. 1 illustrates an exemplary network environment 100 suitable for achieving quick startup of streaming video content. In the exemplary network environment 100, multiple (n) client computing devices 102(1), 102(2), . . . , 102(n) are coupled to multiple (m) content server computing devices 104(1), 104(2), . . . , 104(m) via a network 106. Network 106 is intended to represent any of a variety of conventional network topologies and types (including optical, wired and/or wireless networks), employing any of a variety of conventional network protocols (including public and/or proprietary protocols). Network 106 may include, for example, the Internet as well as possibly at least portions of one or more local area networks (LANs) and/or wide area networks (WANs).

Requests from a client device 102 for streaming media content that is available on a content server device 104 are routed from the client device 102 to the server device 104 via network 106. The content server device 104 receives the request and returns the requested content to the requesting client device 102 via network 106. One or more proxy servers (not shown) may be part of network 106, and requests from client device 102 and responses to client device 102 may be sent to and received from such a proxy server(s) rather than the actual content server device 104. Whatever device (whether it be a content server, proxy server, or other device) is streaming media content to a client device 102 may be referred to as the source device for that streaming media content.

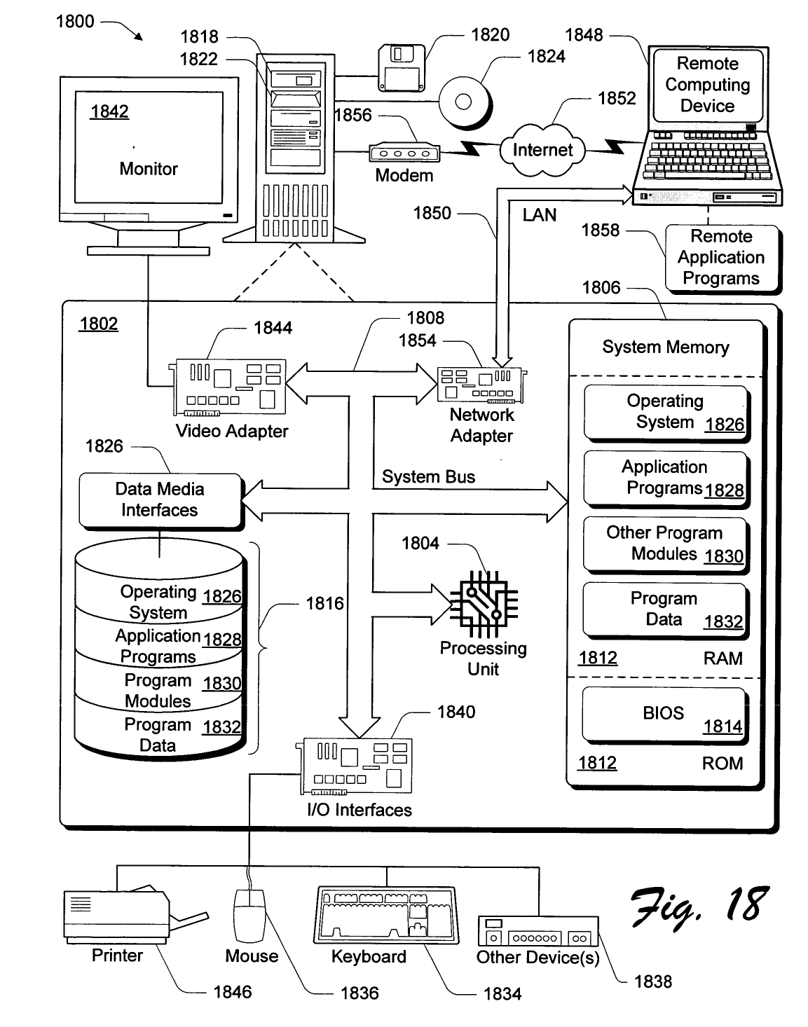

Computing devices 102 and 104 can each be any of a variety of conventional computing devices, including desktop PCs, notebook or portable computers, workstations, mainframe computers, Internet appliances, gaming consoles, handheld PCs, cellular telephones or other wireless communications devices, personal digital assistants (PDAs), combinations thereof, and so on. One or more of devices 102 and 104 can be the same types of devices, or alternatively different types of devices. An exemplary computing environment for implementing a client computing device 102 and a content server computing device 104 is described in more detail herein below with reference to FIG. 18.

Content server devices 104 can make any of a variety of data available for streaming to clients 102. As used herein, “streaming media”, “streaming video”, “video content”, “video clip”, and any variation thereof generally includes audio/video content. The term “streaming” is used to indicate that the data representing the media content is provided over a network to a client device and that playback of the content can begin prior to the content being delivered in its entirety. The data may be publicly available or alternatively restricted (e.g., restricted to only certain users, available only if the appropriate fee is paid, etc.). The data may be any of a variety of one or more types of content, such as audio, video, text, images, animation, etc. Additionally, the data may be “on-demand” (e.g., pre-recorded and of a known size) or alternatively “broadcast” (e.g., having no known size, such as a digital representation of a concert being captured as the concert is performed and made available for streaming shortly after capture).

### EXEMPLARY EMBODIMENTS

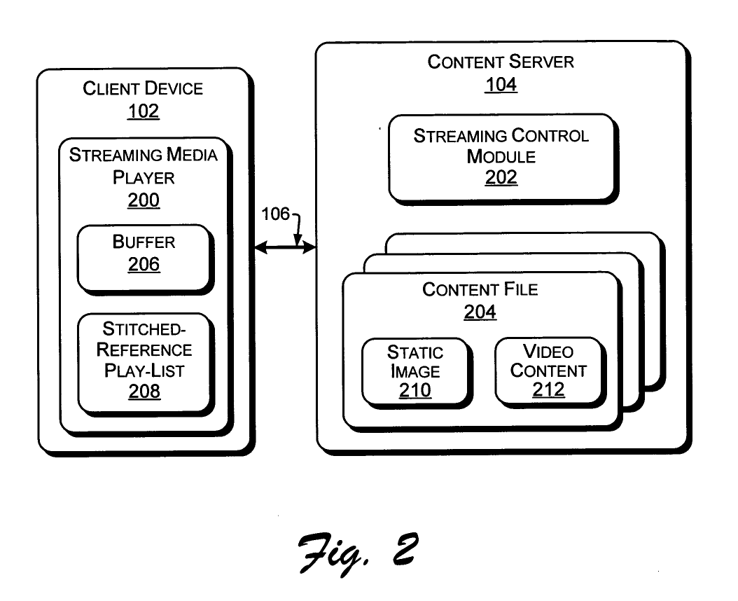

FIG. 2 illustrates an exemplary embodiment of a client device and a server device configured to achieve quick startup when playing back streaming video content on a streaming media player. Client device 102 includes a streaming media player 200 configured to access a streaming control module 202 of a content server device 104. As mentioned above, content server device 104 may be any typical source server device or appropriate alternative device such as, for example, a proxy server device. Although not shown in FIG. 2, one or more additional devices (e.g., firewalls, routers, gateways, bridges, multiple proxy servers, etc.) may be situated between client device 102 and content server device 104. It should be noted that multiple clients 102 may access content server 104 and that a single client 102 may access multiple content servers 104, although only a single client 102 and content server 104 have been shown in FIG. 2 for ease of explanation.

Content server device 104 includes one or more streaming media content files 204 from which a selection can be made by media player 200 (e.g., based on user input at player 200) on client device 102. Selections are made through streaming control module 202 and selected content files 204 are streamed to player 200. Client device 102 includes a buffer 206 that is used to buffer streaming media content received from content server 104. Streaming media player 200 is configured to buffer and play back streaming media content in accordance with a stitched-reference play-list 208. Although illustrated as part of streaming media player 200, both the buffer 206 and stitched-reference play-list 208 may alternatively be separate from streaming media player 200.

Streaming control module 202 typically streams media content to a streaming media player 200 at the steady state rate of the streaming media content. Typically, the steady state rate of the streaming media content is the rate at which the streaming media content is encoded for playback (typically referred to as the encoded bit rate of the content), although alternatively this rate may vary. Different content can be encoded at different rates, which generally affect the quality of the content. Higher encoded bit rates typically result in higher quality content playback. Additionally, different portions of content can be encoded at different rates, also referred to as variable bit rate encoding (e.g., quiet periods of a song may be encoded at 60 kbps (kilobits per second) while more “active” portions of the song may be encoded at 150 kbps).

Communication between devices 102 and 104 can occur using a variety of different protocols. In one implementation, communication between devices 102 and 104 occurs using a version of the HyperText Transport Protocol (HTTP), such as version 1.0 (HTTP 1.0) or version 2.0 (HTTP 2.0). In another implementation, communication between devices 102 and 104 occurs using the Real Time Streaming Protocol (RTSP), such as RTSPU (RTSP used with User Datagram Protocol (UDP)) and/or RTSPT (RTSP used with Transmission Control Protocol (TCP)). Alternatively, other protocols may be used, such as the Session Initiation Protocol (SIP), the Simple Object Access Protocol (SOAP), the Microsoft Media Server (MMS) protocol (such as MMSU (MMS used with UDP) or MMST (MMS used with TCP), and so forth.

Additionally, streaming media content can be stored and streamed in accordance with any of a variety of different streaming media formats. In one exemplary implementation, media is streamed in accordance with the ASF format (Advanced Systems Format or Advanced Streaming Format). Additional information regarding ASF is available from Microsoft® Corporation of Redmond, Wash. Alternatively, or in conjunction with the ASF format, other streaming media formats may be used such as WMA (Windows Media Audio), WMV (Windows Media Video), MPEG (Moving Pictures Experts Group)-1, MPEG-2, MPEG-4, Quicktime, etc.

Different pieces of streaming media content are illustrated in FIG. 2 as different content files 204. In general, a piece of streaming media content may be stored as multiple files, depicted for example, by content files 204, static image files 210, and video content files 212. The manner in which a “piece” of content is defined can vary by implementation and can be based on the type of media. For example, for video content, each video clip can be a piece of content. Content may be separated into pieces along natural boundaries (e.g., different video clips), or alternatively in other arbitrary manners (e.g., every five minutes of content is a piece).

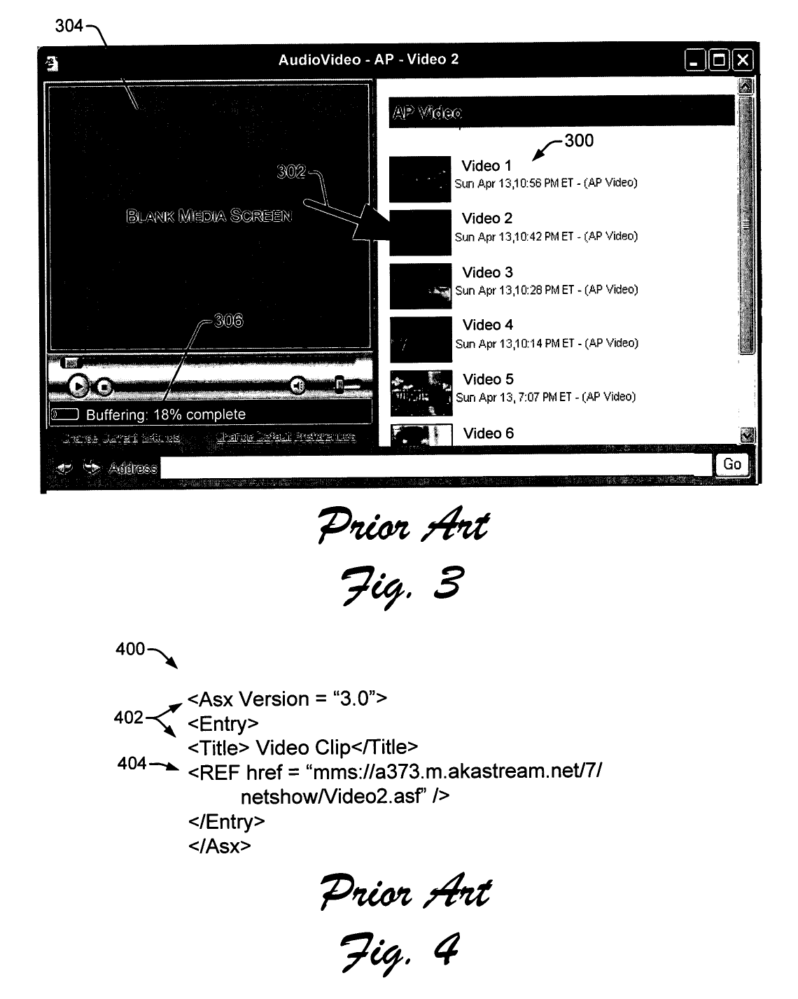

FIGS. 3, 4 and 5 generally illustrate an exemplary prior art process for accessing streaming video content via a streaming media player such as the streaming media player 200 of FIG. 2. FIG. 3 shows an example graphical user interface of a streaming media player being implemented through an Active X control in an HTML window. The HTML window of FIG. 3 illustrates an example of a news-oriented web site offering access to video clips 300 of daily news events. It should be noted that streaming media players may generally be implemented in various forms such as a stand-alone application executing on a client computing device 102, for example, or as an HTML embedded player as illustrated in FIG. 3.

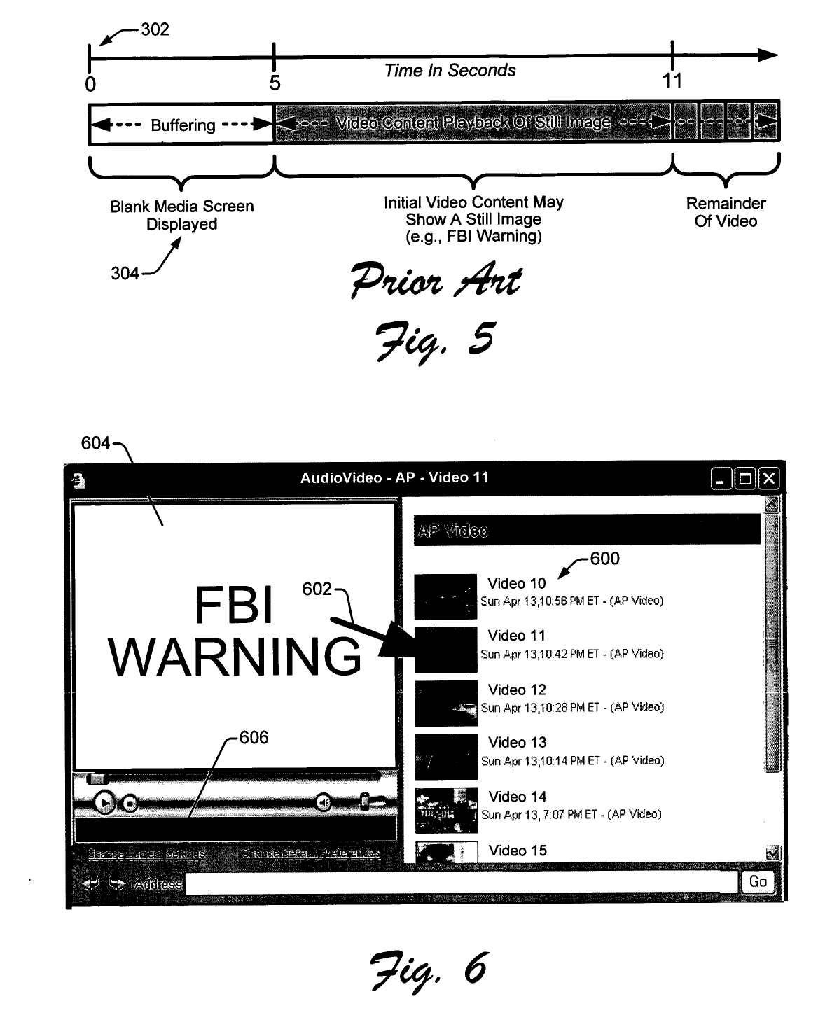

As indicated in FIG. 3, a user may select 302 video content (e.g., Video 2) by clicking on a video link 300 from an HTML-based Internet web page. A video link 300 generally points to a play-list that contains one or more references to iivideo content. FIG. 4 illustrates an example of a play-list 400 in the prior art that might represent a play-list accessed during the scenario of FIG. 3 in which a user selects Video 2 for playback. A play-list 400 generally includes one or more references to various media content along with instructions to control a streaming media player regarding the access, buffering, and playback of the media content. A play-list 400 may be stored on any of various server devices accessible to client device 102 via network 106, but is more typically stored either on the server that supports the web site providing the link 300 to the media content or on the content server 104 that stores the media content to which the play-list 400 refers.

The example prior art play-list 400 of FIG. 4 is implemented as an ASX metafile, which is a type of Windows Media metafile used with Windows Media Player®. The ASX file generally redirects streaming media content away from a browser to Windows Media Player. Other types of metafiles are available for other streaming media players, such as RAM or RPM metafiles used for Real System's RealPlayer. In general, play-lists implemented as ASX metafiles include various ASX syntax elements that provide identification information 402 about the file, such as the type of file, the author, the title, and so on. ASX metafiles also include reference information 404 that includes a path to various media content such as streaming video content. The example play-list 400 of FIG. 4 provides a media player with the location to streaming video content, such as the content for Video 2 as shown in FIG. 3.

A streaming media player implements a play-list 400 and accesses the referenced content in the order in which it appears in the play-list 400. Although there is only one reference to content (i.e., to Video2.asf) in the example play-list 400 of FIG. 4, play-lists commonly have a number of references to streaming 11 content. A streaming media player begins buffering the referenced streaming video content and begins playing it back as soon as the buffer is completely filled. A buffer in a media player (e.g., buffer 206 in media player 200) can usually be set by a user to contain a certain amount of pre-stored content. Buffers are typically set to store content that will support an amount of playback time on the order of 3 to 5 seconds. Because the steady state rate of streaming media content is typically the rate at which the streaming media content is encoded for playback, a 5 second buffer setting, for example, would generally result in a 5 second waiting period from the time a user makes a video selection to the time the buffer is full and the video playback begins.

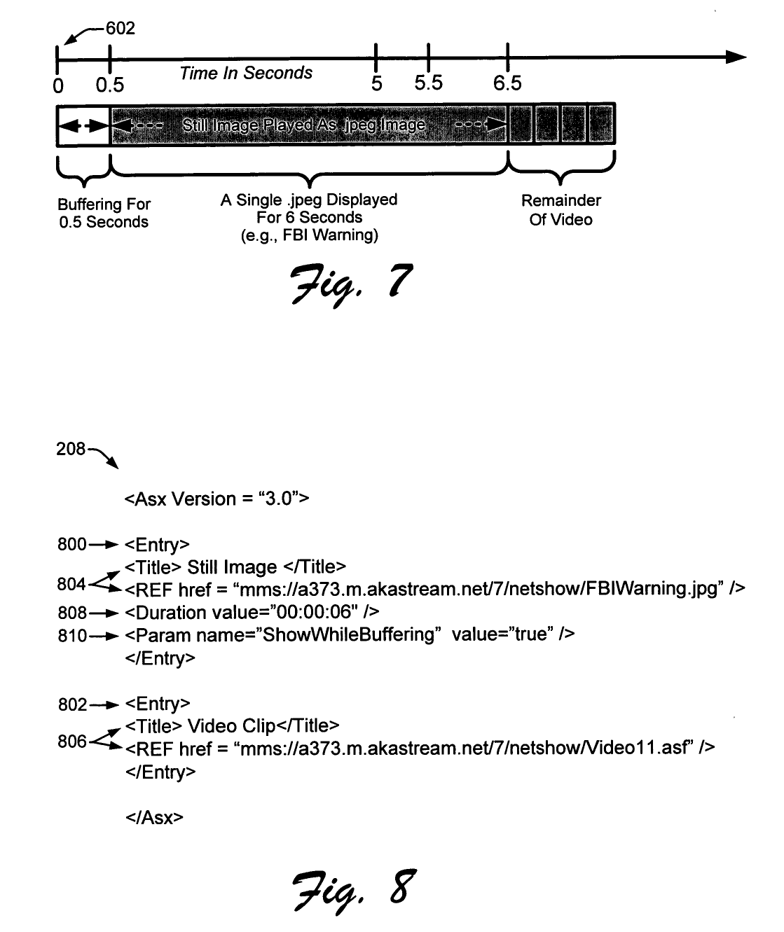

FIG. 5 illustrates an example of a time line for buffering and playing back video content where a media player buffer is set for 5 seconds. This example time line is applicable to the exemplary prior art process discussed above with respect to FIG. 3. Thus, at time zero 302 (FIG. 5) a user selects 302 Video 2 (FIG. 3) for playback. The user then experiences a delay while the video content buffers. During the buffering delay, the user sees a blank media screen 304 and a buffering message 306 that indicates a certain percentage of the buffering is complete (e.g., 18% complete). FIG. 5 illustrates that the buffer time has been set to 5 seconds. The blank media screen 304 is displayed until the buffering is 100% complete, which typically occurs 5 seconds after the video selection is made, since the steady state rate of streaming media content is typically the rate at which the streaming media content is encoded for playback. However, the delay period and display time of a blank media screen 304 may vary depending on network glitches and other factors that can affect the data transfer rate and buffering time. The video selection (i.e., Video 2) begins playing back when the buffer is full.

In addition to showing how a user experiences a buffering delay upon making a video selection, the time line of FIG. 5 also illustrates how the first portion of the video content to be played back may simply comprise a static/still image such as, for example, an “FBI WARNING”. Thus, after the buffering delay of 5 seconds, the user may also wait an additional period of time as a still image is displayed (e.g., 6 seconds as shown in the example of FIG. 5). Assuming the video is 25 frames per second, for example, the first 6 seconds of the video may require the buffering of between 1 and 150 frames, depending on how the content was encoded. These frames are then rendered with no change in the actual display of the video content. Only after the original still image has buffered, can the remaining video content begin to buffer. Thus, even though the still video image displays only a single static image for 6 seconds, it nevertheless requires time to fully buffer as if it were typical dynamic video content. Depending on how many frames are being buffered for the still video image, the buffering of the remaining dynamic video content could begin as much as 6 seconds later. These delays are significant drawbacks to the overall experience of a streaming video experience.

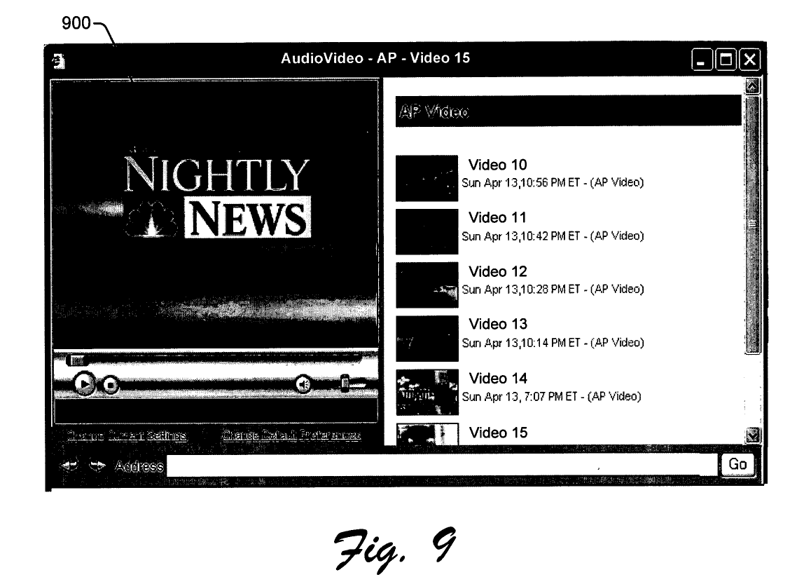

Accordingly, an embodiment is described with reference to FIGS. 2, 6, 7 and 8 that illustrates quick startup of streaming video content on a streaming media player 200. FIG. 6 is similar to FIG. 3 above in that it illustrates an example graphical user interface of a streaming media player 200 being implemented through an Active X control in an HTML window. The HTML window illustrates an example of a news-oriented web site offering access to video clips 600 of daily news events. FIG. 6 is intended to indicate a user selecting (with pointer 602) video content titled Video 11. Unlike the prior art example of FIG. 3, the FIG. 6 embodiment is intended to indicate that an “FBI WARNING” screen 604 is displayed almost directly (i.e., without delay) after a user selects the video content. In addition, the buffering message 306 previously displayed in the FIG. 3 example is not displayed at location 606 in the FIG. 6 embodiment.

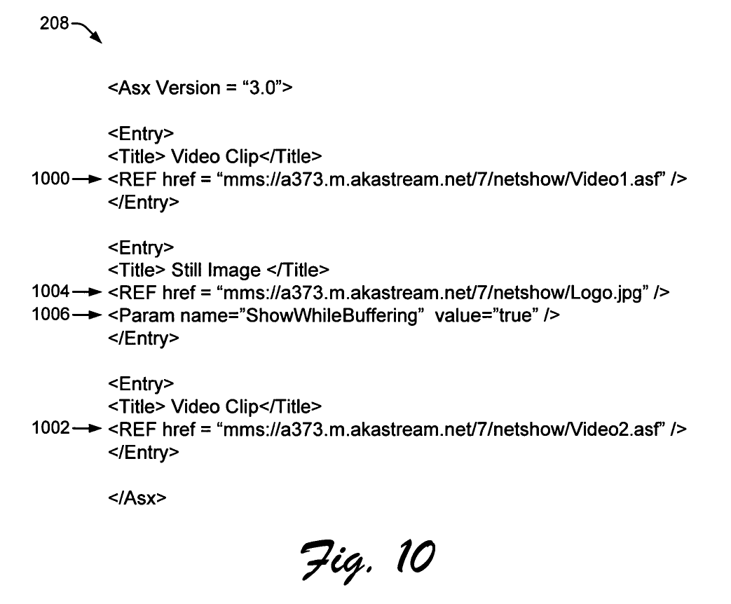

The timing for buffering and playback of the Video 11 content of FIG. 6 is illustrated by the video playback timeline of FIG. 7. FIG. 7 shows that Video 11 is selected at time zero 602. A still image configured, for example, as a “JPEG” (Joint Photographic Experts Group) file (i.e., the FBI Warning), is then buffered for a short period of time (e.g., 0.5 seconds). After the FBI Warning JPEG is buffered, it is displayed for 6 seconds. This is similar to the 6 second display of the static video image of the FBI Warning discussed above regarding FIGS. 3-5. However, the still image in the current embodiment of FIGS. 6 and 7 is rendered as a single image JPEG file, rather than as numerous frames of video content as in the prior art example of FIGS. 3-5. Thus, the FBI Warning is displayed in FIG. 6 as a still image JPEG file until 6.5 seconds on the timeline of FIG. 7. In addition, since the FBI Warning is displayed as a still image JPEG file, the moment it is done buffering and begins being displayed, the remainder of the video content can begin buffering in the background. If the buffer time is set to 5 seconds, for example, the remaining video content will be fully buffered at 5.5 seconds. Thus, if necessary, the remaining video content could begin playing at 5.5 seconds.

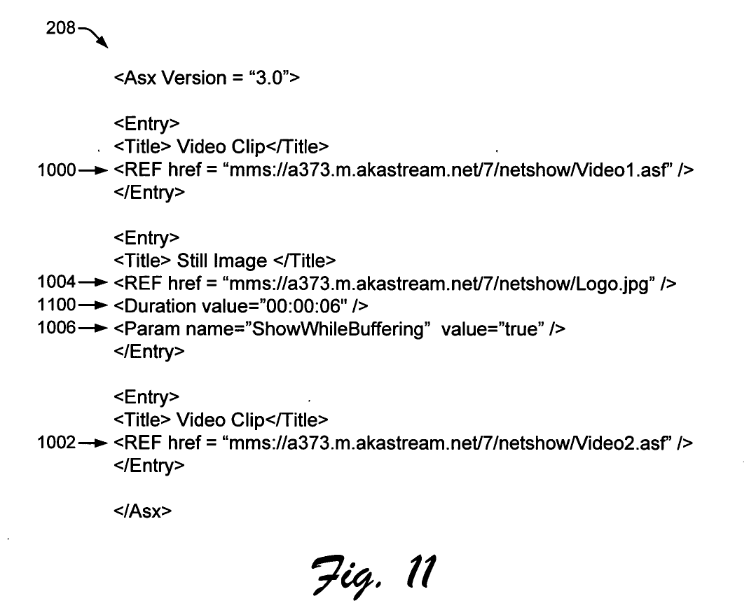

FIG. 8 illustrates an embodiment of a stitched-reference play-list 208 (FIG. 2) that is configured (e.g., by a content provider) to control a streaming media player 200 to access, buffer, and playback the Video 11 content as discussed above with respect to FIGS. 6 and 7. The discussion above regarding a typical play-list 400 is generally applicable to a stitched-reference play-list 208. Thus, a stitched-reference play-list 208 is configured and implemented in much the same way as a typical play-list 400. However, as defined and used herein, a stitched-reference play-list 208 is distinguishable from a typical play-list in one or more ways.

For example, a stitched-reference play-list 208 refers to a single play-list file that includes a reference to a static image and a reference to video content that are “stitched” together in the play-list file in order to facilitate a quick startup of streaming video content through a streaming media player 200 that is capable of supporting the playback of still images in popular formats such as JPEGs (Joint Photographic Experts Group), GIFs (Graphics Interchange Format), PNGs (Portable Network Graphics), and the like. Thus, in general, a content provider can facilitate quick startup of streaming video content by providing the content as two pieces stitched together in a stitched-reference play-list 208 configured, for example, as an ASX play-list file. The first piece of content would be a static image, and the second piece would be the remaining dynamic video content. In addition, a stitched-reference play-list 208 may also include instructions to control the playback of a static image 210 with respect to the playback of video content 212 that are included in one or more content files 204 on a content server 104 such as shown in FIG. 2.

Accordingly, the FIG. 8 embodiment of a stitched-reference play-list 208 includes two entries 800 and 802; the first entry 800 providing a reference to the FBIWarning.jpg still image 804 displayed as 604 in FIG. 6, and the second entry 802 providing a reference to the remaining dynamic video content of Video11.asf 806 that has been selected 602 in FIG. 6. Thus, when a user selects video content 600 as shown in FIG. 6, such as Video 11, for example, a link is made to a stitched-reference play-list 208 such as that shown in FIG. 8. The stitched-reference play-list 208 may be accessed by a media player 200 from a content server 104 such as illustrated in FIG. 2, or it may be accessed from any other device on which it might be stored that is accessible via network 106.

A streaming media player 200 implements the stitched-reference play-list 208 in the same manner as it would implement a typical play-list. That is, the streaming media player 200 accesses the referenced content in the order in which it appears in the play-list 208. In addition, however, the streaming media player 200 implements commands in the stitched-reference play-list 208 that facilitate the 19 quick display of referenced content and transitions between the referenced content. For example, in accordance with the stitched-reference play-list 208 of FIG. 8, when a user selects Video 11 as shown in FIG. 6, a streaming media player 200 first accesses and buffers the FBIWarning.jpg still image 804. As shown in FIG. 7, the buffering of a still image 804 can occur in a very short period of time, such as 0.5 seconds. Thus, after a mere 0.5 seconds from the moment video content is selected, a user experiences content displayed by the streaming media player 200. The media player 200 continues to implement the stitched-reference play-list 208 of FIG. 8 by executing a “Duration” command 808 and a “ShowWhileBuffering” command 810. As these commands are executed, the streaming media player 200 buffers the remaining dynamic video content of Video 11 806 that is referenced in the second entry 802. The duration command 808 is set to a value of 6 seconds, which means that the media player 200 will display the still image 804 (i.e., the FBIWarning.jpg) for at least 6 seconds. Because the value of the ShowWhileBuffering command 810 is set to “true”, the media player 200 will additionally ensure that the still image 804 continues to be displayed until the remaining video content of Videoll.asf 806 is fully buffered. Thus, the stitched-reference play-list 208 of FIG. 8 directs the streaming media player 200 to display the still image 804 (i.e., the FBIWarning.jpg) for as long as it takes the remaining video content of Video11.asf 806 to be fully buffered, but at least for 6 seconds.

Revisiting the timeline of FIG. 7 is helpful in describing the stitched- reference play-list 208 of FIG. 8. When a user selects Video 11 at time zero 602, the streaming media player 200 is directed by a link to the stitched-reference play-list 208 of FIG. 8. The media player 200 implements the play-list 208 by accessing referenced content in the order in which it appears in the play-list 208. Thus, the FBIWarning.jpg still image 804 is accessed and buffered. It takes approximately 0.5 seconds to buffer the still image 804. As FIG. 7 indicates, the media player 200 displays the still image 804 after it is buffered. FIG. 7 additionally shows how the still image 804 remains displayed for 6 full seconds as directed by the duration command 808 in the stitched-reference play-list 208 of FIG. 8. During the 6 seconds, since the still image 804 is already fully buffered and being displayed, the streaming media player 200 can buffer the remaining video content of Video11.asf 806. Since the buffer in the media player 200 is set to 5 seconds, the remaining video content of Videol 11.asf 806 is usually fuilly buffered within 5 seconds from the moment that the still image 804 begins being displayed (i.e., at 0.5 seconds). Thus, the remaining video content, of Videoll.asf 806 is fully buffered at 5.5 seconds (FIG. 7). Therefore, the remaining video content of Videol I .asf 806 could begin playing back starting at 5.5 seconds. However, the duration command 808 in the stitched-reference play-list 208 of FIG. 8 ensures that the FBIWarning.jpg still image 804 is displayed for at least a full 6 seconds. Therefore, the remaining video content of Video11.asf 806 does not begin playing back until 6.5 seconds. Although not illustrated by the timeline of FIG. 7, if the remaining video content of Video11.asf 806 were not fully buffered by the end of the 6 seconds designated by the duration command 808, the ShowWhileBuffering command 810 would ensure that the FBIWarning.jpg still image 804 continued to be displayed until the remaining video content of Videol I .asf 806 was fully buffered.

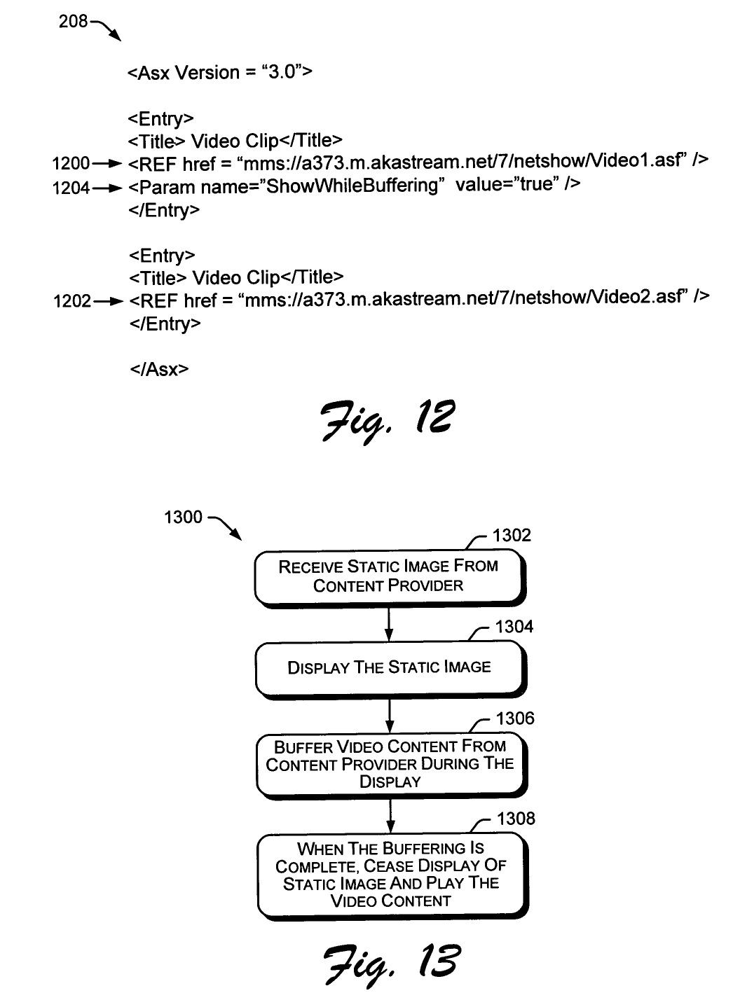

Various additional and alternative implementations are possible regarding the embodiment described above with respect to FIGS. 6-8. As described above, the embodiment applies to video content that happens to begin with a still image (e.g., the FBIWarning.jpg). Thus, the still image 804 referenced in the stitched-reference play-list 208 is typically the first video frame of the video content extracted out by a content provider as a JPEG (Joint Photographic Experts Group), GIF (Graphics Interchange Format), PNG (Portable Network Graphics), or other similarly formatted image file format. However, in another alternate implementation, video content may not begin with a still image. In such an implementation, a content provider or redistributor may insert its own still image in JPEG, GIF, or PNG format. Such a still image may include a company logo image, an advertisement image, and so on. FIG. 9 provides an example of such a still image wherein a redistributor has inserted a still image of its logo 900 to be displayed upon selection of video content so that the logo appears for a period of time as the selected video content buffers in the background.

In another alternate implementation, instead of a single still image being displayed, several still images might be manipulated and displayed to provide the effect of animation. Thus, instead of a stitched-reference play-list 208 referencing a single still image, it would reference several still images that would be buffered and displayed as an animated image prior to and during the buffering of the selected video content. Again, an animated image might include a company logo, an advertisement, and so on. Other implementations may provide variations which apply other digital animation effects to a still image. Such variations include, for example, slowly fading a still image in over a period of time while the video clip is buffering. The still image could also fade out or “crumble” out once the video clip is buffered and ready to play. Such digital animation effects can be specified as part of the play-list 208 format. As an example, tags can be included in an ASX play-list file that instruct the media player 200 to fade out the still image or produce a slow shattering effect of the still image when the video clip is ready to play. In general, such effects may be applicable in various alternate scenarios described throughout this disclosure, some of which are discussed below.

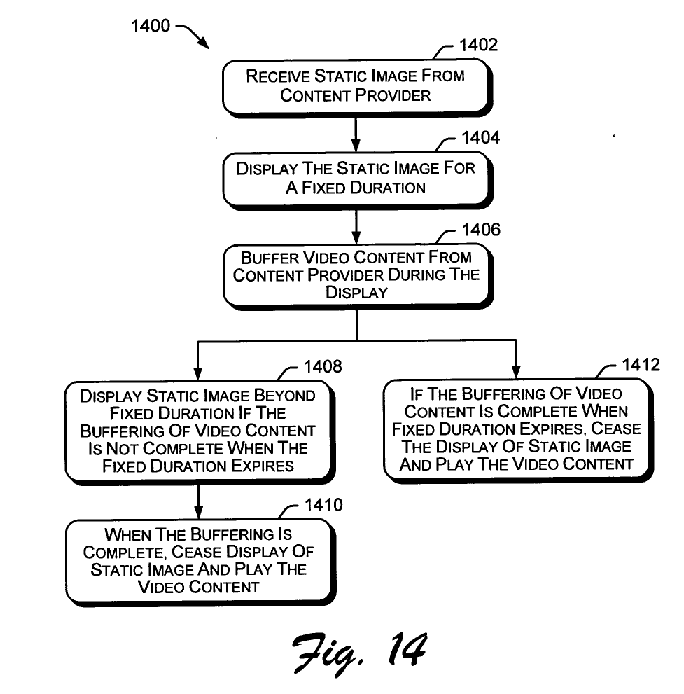

The stitched-reference play-list 208 of FIG. 10 illustrates another exemplary embodiment that achieves seamless startup and transitions between streaming video content on a streaming media player 200 using still images as interstitials. In this embodiment, a content provider can insert a still image in between video clips that are intended to play one after the other. Inserting the still image can smooth over the transition between two video streams. Although a second video stream typically can be buffered as the last part of a first video stream is being played on a media player 200, the transition from playing the first video stream to playing the second video stream is often not a seamless transition. This may be because of network glitches or because the streaming for the first clip does not end in time to fully buffer the second clip. In such circumstances, a stitched-reference play-list 208 such as that shown in FIG. 10 can be used to provide a seamless transition between video clips.

The stitched-reference play-list 208 of FIG. 10 refers to video content that combines 2 video clips, Video1.asf 1000 and Video2.asf 1002, for playback on a streaming media player 200. The media player 200 initially buffers and plays Video1.asf 1000. When playback of Video1.asf 1000 is coming to an end and Video1.asf 1000 is no longer buffering, a still image Logo.jpg 1004 buffers and is displayed by the streaming media player 200. As in the above embodiments, the still image 1004 takes only a very short time to buffer, causing it to be displayed virtually immediately upon the conclusion of Video1.asf 1000. Once the still image Logo.jpg 1004 begins being displayed, the media player 200 begins buffering Video2.asf 1002. The Show WhileBuffering command 1006 following the reference to the still image Logo.jpg 1004 ensures that the still image Logo.jpg 1004 will be displayed until the second video clip (i.e., Video2.asf 1002) is fully buffered and able to begin playback. In an alternate implementation, where available network bandwidth and other factors enable buffering of both the still image Logo.jpg 1004 and the second video clip, Video2.asf 1002, prior to the end of the currently playing Video1.asf 1000, the ShowWhileBuffering command 1006 which follows the reference to the still image Logo.jpg 1004 enables the second video clip, Video2.asf 1002, to begin playing directly after the first video clip, Videol.asf 1000, is completed. Thus, the still image Logo.jpg 1004 would not need to be displayed at all. The still image Logo.jpg 1004 could be skipped over and the media player could immediately begin playing the second video clip, Video2.asf 1002.

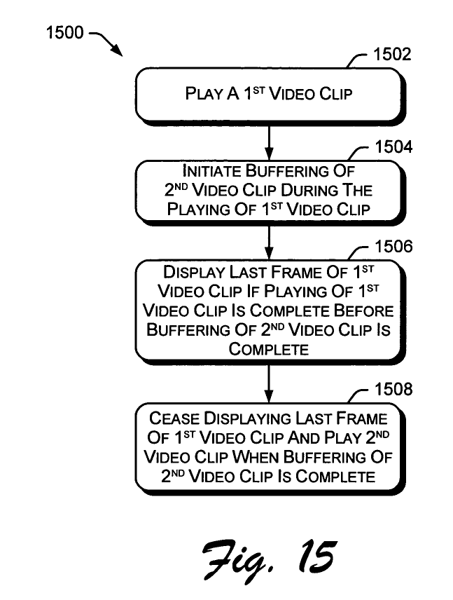

Also, as noted above, alternate implementations of this embodiment may include the use of several still images being manipulated and displayed to provide the effect of animation. Thus, instead of a stitched-reference play-list 208 referencing a single still image, it may reference several still images that would be buffered and displayed as an animated image during the buffering of the second video clip. Again, an animated image might include a company logo, an advertisement, and so on. In addition, other implementations may provide variations that apply other digital animation effects to a still image. Such variations include, for example, slowly fading a still image in over a period of time while the second video clip is buffering. The still image could also fade out or “crumble” out once the second video clip is buffered and ready to play. A variation of the stitched-reference play-list 208 embodied in FIG. 10 is shown in the play-list 208 of FIG. 11. The play-list 208 of FIG. 11 includes a “duration” command 1100 following the reference to the still image Logo jpg 1004 and preceding the ShowWhileBuffering command 1006. As discussed herein above with regard to another embodiment, this combination of duration and ShowWhileBuffering commands causes the streaming media player 200 to ensure that the still image Logo.jpg 1004 is displayed for at least the amount of time specified by the duration command 1008 (i.e., 6 seconds as shown in FIG. 11). If however, the second video clip, Video2.asf 1002, is not fully buffered by the time the 6 seconds is completed, then the ShowWhileBuffering command 1006 will cause the media player 200 to continue displaying the still image Logo.jpg 1004 until the video clip, Video2.asf 1002, is fully buffered. Again, as in the FIG. 10 embodiment, variations of the FIG. 11 embodiment are possible, such as the use of several still images being manipulated to provide an animation, and digital animation effects applied that slowly fade a still image in or out over a period of time while the second video clip is buffering.

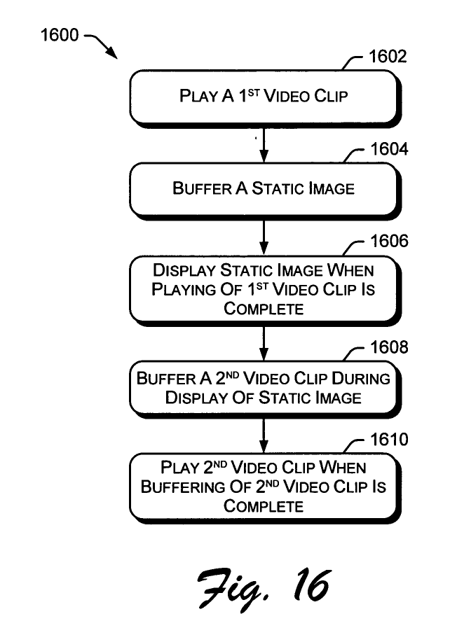

The stitched-reference play-list 208 of FIG. 12 illustrates still another exemplary embodiment that achieves seamless startup and transitions between streaming video content on a streaming media player 200 using still images as interstitials. In the FIG. 12 embodiment, the still image is not inserted by a content provider. Rather, the still image is the last frame of a preceding video clip. A content provider can ensure that the transition between a first video clip and a second video clip will not result in a blank screen in the event that the second video clip is not fully buffered by the time the first video clip has finished playing. This is accomplished by maintaining the streaming media player 200 display with the last frame of the first video clip until the second video clip is fully buffered. In another alternate implementation, several frames of the preceding video clip may be manipulated in such a way as to create an animated image when they are played back. As in the several embodiments discussed above, the FIG. 12 embodiment contemplates implementations in which digital animation effects can be applied to a single still image (e.g., the last frame of the preceding video clip), such as slowly fading a still image in or out over a period of time while the second video clip is buffering.

In a manner similar to the embodiments of FIGS. 10 and 11, the stitched-reference play-list 208 of FIG. 12 refers to video content that combines 2 video clips, Video1.asf 1200 and Video2.asf 1202, for playback on a streaming media player 200. The media player 200 initially buffers and plays Video1.asf 1200. When playback of Video l.asf 1200 is coming to an end and Video1.asf 1200 is no longer buffering, Video2.asf 1202 begins to buffer. Because it is likely that Video1.asf 1200 and Video2.asf 1202 have the same streaming rate, and the steady state rate of streaming media content is typically the rate at which the streaming media content is encoded for playback, Video2.asf 1202 will likely begin playback directly upon completion of playback of Video1.asf 1200. That is, it is generally expected that Video2.asf 1202 will be fully buffered and ready to begin playback at precisely the time that playback of Video1.asf 1200 ends. However, due to various factors that may affect the data streaming rate, Video2.asf 1202 may not be fully buffered by the time playback of Video1.asf 1200 ends. In the past, this scenario would result in a blank media screen between the time when playback of Video1.asf 1200 ended and the time when Video2.asf 1202 was fully buffered. However, the ShowWhileBuffering command 1204 included in the stitched-reference play-list 208 of FIG. 12 functions to prevent a blank media screen from being displayed under such circumstances. The ShowWhileBuffering command 1204 causes a streaming media player 200 to maintain the display with a still image of the last frame of Video1.asf 1200 until such time as Video2.asf 1202 is fully buffered. Thus, there is a seamless and smooth transition between the two pieces of streaming video content.

It is noted that alternate embodiments are contemplated that include various combinations and/or extensions of the embodiments illustrated by the stitched reference play-lists 208 of FIGS. 8, 10, 11 and 12. For example, the embodiment of FIG. 8 generally illustrates the use of a still image 804 to achieve quick startup for video content and certain play-list commands (i.e., Duration and ShowWhileBuffering commands) to control the length of display for the still image 804 until such time as video content (i.e., Video 11.asf 806) is buffered and ready for playback. The embodiment of FIG. 10 generally illustrates a quick startup and smooth transition between two video clips. Thus, in an alternate embodiment, a play-list 208 such as that shown in FIG. 8 may be combined appropriately with a play-list 208 such as that shown in FIG. 10 to provide quick startup for video content and smooth transitions between video clips with respect to any number of video clips that may be stitched together in a stitched-reference play-list 208.

### EXEMPLARY METHODS

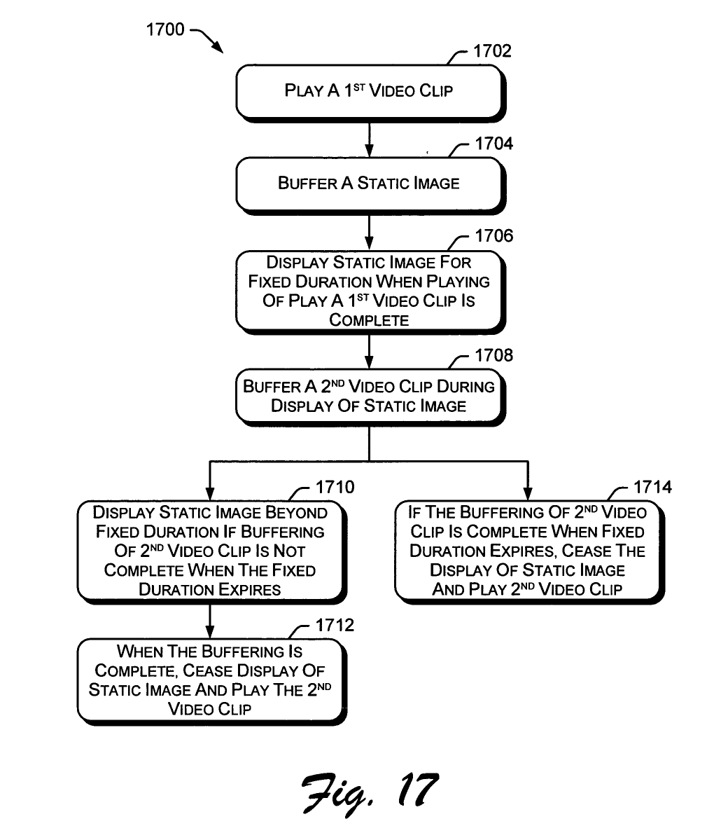

Example methods for achieving quick startup of video content in a streaming media player will now be described with primary reference to the flow diagrams of FIGS. 13-17. The methods apply generally to the exemplary embodiments discussed above with respect to FIG. 2 and FIGS. 6-12. The elements of the described methods may be performed by any appropriate means including, for example, by hardware logic blocks on an ASIC or by the execution of processor-readable instructions defined on a processor-readable medium.

A “processor-readable medium,” as used herein, can be any means that can contain, store, communicate, propagate, or transport instructions for use by or execution by a processor. A processor-readable medium can be, without limitation, an electronic, magnetic, optical, electromagnetic, infrared, or semiconductor system, apparatus, device, or propagation medium. More specific examples of a processor-readable medium include, among others, an electrical connection (electronic) having one or more wires, a portable computer diskette (magnetic), a random access memory (RAM) (magnetic), a read-only memory (ROM) (magnetic), an erasable programmable-read-only memory (EPROM or Flash memory), an optical fiber (optical), a rewritable compact disc (CD-RW) (optical), and a portable compact disc read-only memory (CDROM) (optical).

FIG. 13 shows an exemplary method 1300 for achieving quick startup of video content in a streaming media player 200. At block 1302, a streaming media player 200 (e.g., on a client computing device 102) receives a static image from a content provider, such as a content server 104. Typically, the receipt of the static image is the result of a user making a video content selection that directs the streaming media player 200 to a play-list, such as a stitched-reference play-list 208. A stitched-reference play-list 208 refers the streaming media player 200 to the static image which the media player 200 requests from the content provider. The static image promptly downloads (e.g., within approximately 0.5 seconds) to the media player 200 where it can be displayed.

At block 1304 of method 1300, the streaming media player 200 displays the static image on a monitor or other type of display device associated with client computing device 102. While the static image is displayed, the streaming media player 200 buffers video content from the content provider, as shown at block 1306. The video content is referenced in the stitched-reference play-list 208 being implemented by the streaming media player 200. At block 1308, when the buffering of the video content is complete, the streaming media player 200 stops displaying the static image and begins playing back the video content. Thus, the static image is displayed quickly and for as long as it takes the video content to buffer and be ready for playback.

FIG. 14 shows another exemplary method 1400 for achieving quick startup of video content in a streaming media player 200. At block 1402, a streaming media player 200 (e.g., on a client computing device 102) receives a static image from a content provider, such as a content server 104. As in the previous method, the receipt of the static image is typically the result of a user making a video content selection that directs the streaming media player 200 to a stitched-reference play-list 208. The static image quickly downloads to the media player 200 where it can be displayed.

At block 1404, the streaming media player 200 displays the static image for a fixed duration on a monitor or other display device associated with client computing device 102. The fixed duration is an amount of time (e.g., several seconds) specified by a “duration” command in the stitched-reference play-list as 208. While the static image is displayed, the streaming media player 200 buffers video content from the content provider, as shown at block 1406. If the fixed duration expires and the video content is not fully buffered, the static image can be displayed beyond the fixed duration, as shown at block 1408. Thereafter, once the buffering of the video content is complete, the streaming media player 200 stops displaying the static image and begins playing back the video content as shown at block 1410. Thus, the static image is displayed for at least the duration specified in the duration command and maybe longer if the video content requires additional time to be fuilly buffered.

At block 1412, another alternative is that the buffering of the video content is complete when the fixed duration for displaying the static image expires. In this case, the streaming media player 200 would stop displaying the static image and begin playing back the video content.

FIG. 15 shows another exemplary method 1500 for achieving quick startup and a smooth transition between two video clips in a streaming media player 200. At block 1502, a streaming media player 200 plays a first video clip. While playing the first video clip, the streaming media player 200 begins buffering a second video clip as shown in block 1504. Typically, the second video clip would be expected to be buffered just in time to begin playback when the first video clip completed playback. However, due to various factors that may affect the data streaming rate, the second video clip may not be fully buffered by the time playback of the first video clip ends. Thus, at block 1506, the streaming media player 200 displays the last frame of the first video clip. The last frame of the first video clip continues to be displayed until the second video clip is fully buffered. As indicated at block 1508, when the buffering of the second video clip is completed, the streaming media player 200 stops displaying the last frame of the first video clip and begins playing back the second video clip.

FIG. 16 shows another exemplary method 1600 for achieving quick startup and a smooth transition between two video clips in a streaming media player 200. At block 1602, a streaming media player 200 plays a first video clip. While playing the first video clip, the streaming media player 200 buffers a static image as shown at block 1604. At block 1606, the static image is displayed upon the completion of playing the first video clip. While the static image is being displayed, a second video clip is buffered as shown at block 1608. At block 1610, the second video clip begins playing back (and the static image is no longer displayed) when the buffering for the second video clip is complete.

FIG. 17 shows another exemplary method 1700 for achieving quick startup and a smooth transition between two video clips in a streaming media player 200. At block 1702, a streaming media player 200 plays a first video clip. While playing the first video clip, the streaming media player 200 buffers a static image as shown at block 1704. At block 1706, the static image is displayed for a fixed duration upon the completion of playing the first video clip. The fixed duration is an amount of time (e.g., several seconds) specified by a “duration” command in a stitched-reference play-list 208 being implemented by the streaming media player 200. While the static image is being displayed, a second video clip is buffered as shown at block 1708.

If the fixed duration expires and the second video clip is not fully buffered, the static image can be displayed beyond the fixed duration, as shown at block 1710. Thereafter, once the buffering of the second video clip is complete, the streaming media player 200 stops displaying the static image and begins playing back the second video clip as shown at block 1712. Thus, the static image is displayed for at least the duration specified in the duration command and maybe longer if the second video clip requires additional time to be fully buffered.

At block 1714, another alternative is that the buffering of the second video clip is complete when the fixed duration for displaying the static image expires. In this case, the streaming media player 200 would stop displaying the static image and begin playing back the second video clip.

While one or more methods have been disclosed by means of flow diagrams and text associated with the blocks of the flow diagrams, it is to be understood that the blocks do not necessarily have to be performed in the order in which they were presented, and that an alternative order may result in similar advantages. Furthermore, the methods are not exclusive and can be performed alone or in combination with one another.

### EXEMPLARY COMPUTER

FIG. 18 illustrates an exemplary computing environment suitable for implementing a client computing device 102 and a content server computing device 104. Although one specific configuration is shown, client computing device 102 and content server computing device 104 may be implemented in other computing configurations.

The computing environment 1800 includes a general-purpose computing system in the form of a computer 1802. The components of computer 1802 can include, but are not limited to, one or more processors or processing units 1804, a system memory 1806, and a system bus 1808 that couples various system components including the processor 1804 to the system memory 1806.

The system bus 1808 represents one or more of any of several types of bus structures, including a memory bus or memory controller, a peripheral bus, an accelerated graphics port, and a processor or local bus using any of a variety of bus architectures. An example of a system bus 1808 would be a Peripheral Component Interconnects (PCI) bus, also known as a Mezzanine bus.

Computer 1802 typically includes a variety of computer readable media. Such media can be any available media that is accessible by computer 1802 and includes both volatile and non-volatile media, removable and non-removable media. The system memory 1806 includes computer readable media in the form of volatile memory, such as random access memory (RAM) 1810, and/or non-volatile memory, such as read only memory (ROM) 1812. A basic input/output system (BIOS) 1814, containing the basic routines that help to transfer information between elements within computer 1802, such as during start-up, is stored in ROM 1812. RAM 1810 typically contains data and/or program modules that are immediately accessible to and/or presently operated on by the processing unit 1804.

Computer 1802 can also include other removable/non-removable, volatile/non-volatile computer storage media. By way of example, FIG. 18 illustrates a hard disk drive 1816 for reading from and writing to a non-removable, non-volatile magnetic media (not shown), a magnetic disk drive 1818 for reading from and writing to a removable, non-volatile magnetic disk 1820 (e.g., a “floppy disk”), and an optical disk drive 1822 for reading from and/or writing to a removable, non-volatile optical disk 1824 such as a CD-ROM, DVD-ROM, or other optical media. The hard disk drive 1816, magnetic disk drive 1818, and optical disk drive 1822 are each connected to the system bus 1808 by one or more data media interfaces 1826. Alternatively, the hard disk drive 1816, magnetic disk drive 1818, and optical disk drive 1822 can be connected to the system bus 1808 by a SCSI interface (not shown).

The disk drives and their associated computer-readable media provide non-volatile storage of computer readable instructions, data structures, program modules, and other data for computer 1802. Although the example illustrates a hard disk 1816, a removable magnetic disk 1820, and a removable optical disk 1824, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 1816, magnetic disk 1820, optical disk 1824, ROM 1812, and/or RAM 1810, including by way of example, an operating system 1826, one or more application programs 1828, other program modules 1830, and program data 1832. Each of such operating system 1826, one or more application programs 1828, other program modules 1830, and program data 1832 (or some combination thereof) may include an embodiment of a caching scheme for user network access information.

Computer 1802 can include a variety of computer/processor readable media identified as communication media. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

A user can enter commands and information into computer system 1802 via input devices such as a keyboard 1834 and a pointing device 1836 (e.g., a “mouse”). Other input devices 1838 (not shown specifically) may include a microphone, joystick, game pad, satellite dish, serial port, scanner, and/or the like. These and other input devices are connected to the processing unit 1804 via input/output interfaces 1840 that are coupled to the system bus 1808, but may be connected by other interface and bus structures, such as a parallel port, game port, or a universal serial bus (USB).

A monitor 1842 or other type of display device can also be connected to the system bus 1808 via an interface, such as a video adapter 1844. In addition to the monitor 1842, other output peripheral devices can include components such as speakers (not shown) and a printer 1846 which can be connected to computer 1802 via the input/output interfaces 1840.

Computer 1802 can operate in a networked environment using logical connections to one or more remote computers, such as a remote computing device 1848. By way of example, the remote computing device 1848 can be a personal computer, portable computer, a server, a router, a network computer, a peer device or other common network node, and the like. The remote computing device 1848 is is illustrated as a portable computer that can include many or all of the elements and features described herein relative to computer system 1802.

Logical connections between computer 1802 and the remote computer 1848 are depicted as a local area network (LAN) 1850 and a general wide area network (WAN) 1852. Such networking environments are commonplace in offices, enterprise-wide computer networks, intranets, and the Internet. When implemented in a LAN networking environment, the computer 1802 is connected to a local network 1850 via a network interface or adapter 1854. When implemented in a WAN networking environment, the computer 1802 typically includes a modem 1856 or other means for establishing communications over the wide network 1852. The modem 1856, which can be internal or external to computer 1802, can be connected to the system bus 1808 via the input/output interfaces 1840 or other appropriate mechanisms. It is to be appreciated that the illustrated network connections are exemplary and that other means of establishing communication link(s) between the computers 1802 and 1848 can be employed.

In a networked environment, such as that illustrated with computing environment 1800, program modules depicted relative to the computer 1802, or portions thereof, may be stored in a remote memory storage device. By way of example, remote application programs 1858 reside on a memory device of remote computer 1848. For purposes of illustration, application programs and other executable program components, such as the operating system, are illustrated herein as discrete blocks, although it is recognized that such programs and components reside at various times in different storage components of the computer system 1802, and are executed by the data processor(s) of the computer.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A processor-readable medium comprising processor-executable instructions configured for:
receiving a static image from a content provider;
displaying the static image; and
buffering video content from the content provider during the displaying.

2. A processor-readable medium as recited in claim 1, comprising further processor-executable instructions configured for:
when the buffering of the video content is complete,
ceasing the displaying of the static image; and
playing the video content:

3. A processor-readable medium as recited in claim 1, wherein the displaying comprises displaying the static image for a fixed duration.

4. A processor-readable medium as recited in claim 3, comprising further processor-executable instructions configured for displaying the static image beyond the fixed duration if the buffering is not complete when the fixed duration expires.

5. A processor-readable medium as recited in claim 3, comprising further processor-executable instructions configured for:
if the buffering is complete when the fixed duration expires,
ceasing the displaying of the static image; and
playing the video content.

6. A processor-readable medium as recited in claim 1, wherein the static image is a plurality of static images comprising an animated image and the displaying comprises displaying the animated image.

7. A processor-readable medium as recited in claim 1, wherein the static image is in a file format selected from the group comprising:
a JPEG (Joint Photographic Experts Group) file format;
a GIF (Graphics Interchange Format) file format; and
a PNG (Portable Network Graphics) file format.

8. A processor-readable medium as recited in claim 1, wherein the receiving comprises:
implementing a play-list that includes a reference to the static image stored on the content provider; and
requesting the static image from the content provider based on the reference.

9. A processor-readable medium as recited in claim 1, wherein the displaying comprises:
implementing a play-list that includes a duration command; and
displaying the static image for a specified duration defined by the duration command.

10. A processor-readable medium as recited in claim 9, wherein the play-list includes a show-while-buffering parameter and the displaying further comprises displaying the static image beyond the specified duration until such time as the buffering is complete.

11. A processor-readable medium as recited in claim 1, wherein the buffering comprises:
implementing a play-list that includes a reference to the video content stored on the content provider; and
requesting the video content from the content provider based on the reference.

12. A media playing device comprising the processor-readable medium as recited in claim 1.

13. A processor-readable medium comprising processor-executable instructions configured for:
playing a first video clip;
initiating buffering of a second video clip during the playing; and
displaying a last frame of the first video clip when the playing of the first video clip is complete and the buffering of the second video clip is not complete.

14. A processor-readable medium as recited in claim 13, comprising further processor-executable instructions configured for ceasing the displaying of the last frame of the first video clip and playing the second video clip when the buffering of the second video clip is complete.

15. A processor-readable medium comprising processor-executable instructions configured for:
playing a first video clip;
buffering a static image;
displaying the static image when the playing of the first video clip is complete; and
buffering a second video clip during the displaying of the static image.

16. A processor-readable medium as recited in claim 15, comprising further processor-executable instructions configured for playing the second video clip when the buffering of the second video clip is complete.

17. A processor-readable medium as recited in claim 15, wherein the displaying comprises displaying the static image for a fixed duration.

18. A processor-readable medium as recited in claim 17, comprising further processor-executable instructions configured for displaying the static image beyond the fixed duration if the buffering of the second video clip is not complete upon expiration of the fixed duration.

19. A processor-readable medium as recited in claim 17, comprising further processor-executable instructions configured for:
if the buffering of the second video clip is complete when the fixed duration expires,
ceasing the displaying; and
playing the second video clip.

20. A processor-readable medium comprising processor-executable instructions configured for:
playing a first video clip;
buffering a static image during the playing;
buffering a second video clip during the playing; and
if the buffering of the second video clip is not complete when the playing of the first video clip is complete, displaying the static image when the playing of the first video clip is complete.

21. A processor-readable medium as recited in claim 20, comprising further processor-executable instructions configured for:
if the buffering of the second video clip is complete when the playing of the first video clip is complete, playing the second video clip when the playing of the first video clip is complete.

22. A play-list comprising:
a reference to a static image;
a duration command that indicates a minimum duration for which the static image must be displayed;
a show-while-buffering parameter set to indicate that the static image must be displayed until a second reference is fully buffered; and
the second reference to a video clip.

23. A play-list as recited in claim 22 further comprising:
a second show-while-buffering parameter set to indicate that a last frame of the video clip must be displayed until a third reference is fully buffered; and
the third reference to a second video clip.

24. A play-list as recited in claim 22 further comprising:
a third reference to a second static image;
a show-while-buffering parameter set to indicate that the second static image must be displayed until a fourth reference is fully buffered; and
the fourth reference to a second video clip.

25. A play-list as recited in claim 24 further comprising:
a duration command that indicates a minimum duration for which the second static image must be displayed.

26. A media playing device configured to display the static image and play the video clip according to the play-list recited in claim 22.

27. A method comprising:
receiving a static image from a content provider;
buffering video content from the content provider; and
displaying the static image until the video content is fully buffered.

28. A method as recited in claim 27, further comprising:
when the video content is fully buffered,
ceasing the displaying of the static image; and
playing the video content.

29. A method as recited in claim 27, wherein the displaying comprises displaying the static image for a fixed duration.

30. A method as recited in claim 29, further comprising displaying the static image beyond the fixed duration if the video content is not fully buffered when the fixed duration expires.

31. A method as recited in claim 29, further comprising:
if the video content is fully buffered when the fixed duration expires,
ceasing the displaying of the static image; and
playing the video content.

32. A method as recited in claim 27, wherein the static image is a plurality of static images comprising an animated image and the displaying comprises displaying the animated image.

33. A method as recited in claim 27, wherein the static image is in a file format selected from the group comprising:
a JPEG (Joint Photographic Experts Group) file format;
a GIF (Graphics Interchange Format) file format; and
a PNG (Portable Network Graphics) file format.

34. A method comprising:
playing a first video clip;
buffering a second video clip during the playing; and
displaying a last frame of the first video clip if the second video clip is not fully buffered when the playing of the first video clip is complete.

35. A method as recited in claim 34, further comprising ceasing the displaying of the last frame of the first video clip and playing the second video clip when the buffering of the second video clip is complete.

36. A method comprising:
playing a first video clip;
buffering a static image;
displaying the static image when the playing of the first video clip is complete; and
buffering a second video clip during the displaying of the static image.

37. A method as recited in claim 36, further comprising playing the second video clip when the buffering of the second video clip is complete.

38. A method as recited in claim 36, wherein the displaying comprises displaying the static image for a fixed duration.

39. A method as recited in claim 38, further comprising displaying the static image beyond the fixed duration if the buffering of the second video clip is not complete upon expiration of the fixed duration.

40. A method as recited in claim 38, further comprising:
if the buffering of the second video clip is complete when the fixed duration expires,
ceasing the displaying; and
playing the second video clip.

41. A streaming media device comprising:
means for receiving a first static image from a content provider;
means for buffering a first video clip from the content provider;
means for displaying the first static image until the first video clip is fully buffered; and
means for playing the first video clip when the first video content is fully buffered.

42. A streaming media device as recited in claim 41, further comprising:
means for buffering a second video clip from the content provider while the first video clip is playing;
means for displaying a last frame of the first video clip until the second video clip is filly buffered; and
means for playing the second video clip when the second video clip is fully buffered.

43. A streaming media device as recited in claim 41, further comprising:
means for buffering a second static image from the content provider while the first video clip is playing;
means for displaying the second static image when the first video clip is done playing;
means for buffering a second video clip during the displaying of the second static image;
means for ceasing the displaying of the second static image and playing the second video clip when the second video clip is filly buffered.
